(19) United States
(12) Patent Application Publication
(10) Pub. No.: US 2005/0258211 A1
(43) Pub. Date: Nov. 24, 2005

(54) Safety control circuit for direct current electromotive nail driver

(76) Inventor: Chao-Yi Chuang, Taichung (TW)

Correspondence Address: Chao-Yi Chuang, 235 Chung - Ho, Box 8-24, Taipei, TW

(21) Appl. No.: 10/847,595

(22) Filed: May 18, 2004

(51) Int. Cl. B25C 1/04

(52) U.S. Cl. 227/8

(57) ABSTRACT

A safety control circuit for a direct current electromotive nail driver comprises: a direct current power source for supplying power to the circuit; a control and protecting unit having a security switch, a trigger switch and a stop switch; and a motor for driving an impact rod to compress an elastomer. When the security switch is turned on and then the trigger switch is pressed, the control and protecting unit will receive a signal from the trigger switch so as to conduct the motor and thus the motor operates to drive an impact rod to compress an elastomer. When the motor operates through a predetermined time period, the stop switch will actuate a protection function of the control and protecting unit so that the motor cannot operate until the security switch is actuated again.

### FIELD OF THE INVENTION

The present invention relates to nail drivers and particular to a safety control circuit for a direct current electromotive nail driver which can provide a preferred protection to the nail driver.

### BACKGROUND OF THE INVENTION

Electric nail drivers are more and more popular to the workers since they can make the people drive nails easily. In the prior art, the electric nail drivers have security switches for preventing the carelessness of people. When a trigger switch is pressed, the nail is beaten. If the security switch does not close, the trigger switch is actuated again, a nail will be beaten. Then, it is possible that an accident occurs. Thereby, the prior art security switch cannot protect a preferred protection.

### SUMMARY OF THE INVENTION

Accordingly, the primary object of the present invention is to provide a safety control circuit for a direct current electromotive nail driver which can provide a preferred protection to the nail driver.

To achieve above objects, the present invention provides a safety control circuit for a direct current electromotive nail driver comprises: a direct current power source for supplying power to the circuit; a control and protecting unit having a security switch, a trigger switch and a stop switch; and a motor for driving an impact rod to compress an elastomer. When the security switch is turned on and then the trigger switch is pressed, the control and protecting unit will receive a signal from the trigger switch so as to conduct the motor and thus the motor operates to drive an impact rod to compress an elastomer. When the motor operates through a predetermined time period, the stop switch will actuates to actuate a protection function of the control and protecting unit so that the motor cannot operate until the security switch SW1 is actuated again.

The various objects and advantages of the present invention will be more readily understood from the following detailed description when read in conjunction with the appended drawing.

### BRIEF DESCRIPTION OF THE DRAWINGS

FIG. 1 shows a block diagram about the safety control circuit for a direct current electromotive nail driver of the present invention.

FIG. 2 is a circuit diagram of the safety control circuit for a direct current electromotive nail driver of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

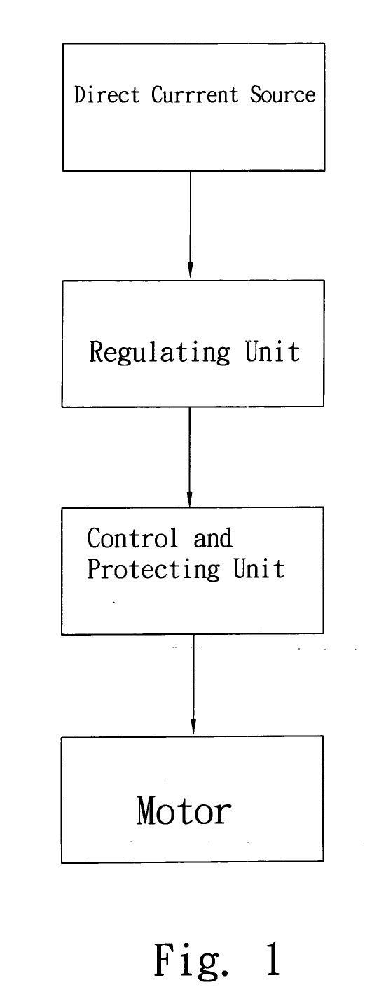

With reference to FIG. 1, the operation block diagram of the present invention is illustrated. In the present invention, a control circuit structure is disclosed. The control circuit has a motor and is actuated by a direct current source. The control circuit includes a regulating unit, a control and protecting unit, and a motor. The regulating unit serves to provide a steady current to the control and protect unit. The control and protecting unit is installed with a security switch, a trigger switch and a stop switch. When the security switch is actuated, the trigger switch is actuated. The motor is conducted. After a small time period, the stop switch is actuated so as to actuate the protection function of the control and protecting unit. When the security switch is not closed and the trigger switch is triggered carelessly, the motor cannot operate. The control and protect unit stops until the user closes the security switch. Thereby, if it is desired to trigger again, the security switch must be turned off and then actuate. Then the trigger switch is pressed and the motor operates again.

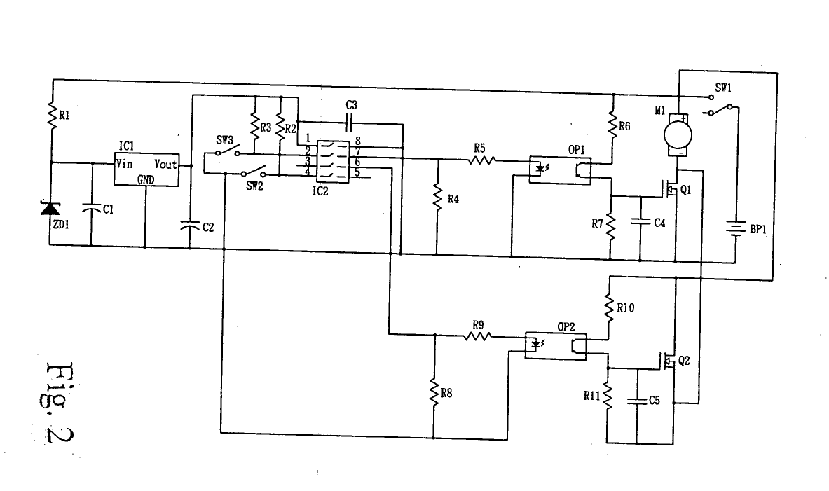

With reference to FIG. 2, the regulating unit includes a Zener diode ZD1 and a regulating IC (IC1) (IC: integrating circuit) and capacitors C1 and C2.

The control and protecting unit is formed by a security switch SW1, a trigger switch SW2 and a stop switch SW3, a single chip controller IC2, two optical coupling ICs (OP1, OP2), and two metal-oxide-semiconductor field effect transistors (MOSFET Q1 and MOSFET Q2).

A direct current power source BP1 serves for supplying power to the circuit.

When the security switch SW1 is turned on, current from the direct current power source BP1 flows through the Zener diode ZD1 so as to confine the voltage to be within 12 Volts. Then the current flows through the regulating IC (IC1) so as to output a steady voltage to the single chip controller IC2. The regulating IC, and the capacitors C1 and C2 serves as a power source lower frequency filter.

When the user presses the trigger switch SW2 through 0.1 second, a seventh pin of single chip controller IC2 is retained in a high level output so as to actuate the optical coupling IC (OP1) so that the voltage is transferred to the gate of the N channel MOSFET Q1 to conduct the source and drain of the MOSFET Q1. Thereby, the MOSFET Q1 and the direct current power source BP1 are formed as a circuit loop. Thereby, the MOSFET Q1 operates. A gear engaged to the MOSFET Q1 will be driven so as to drive an impact rod to displace and compress an elastomer to store potential energy. When the MOSFET Q1 rotates through a small time period, the gear or impact rod driven by the motor will contact the stop switch SW3. Then the seventh pin of the single chip controller IC2 will output a low level voltage and the sixth pin of the single chip controller IC2 will output a high voltage. The seventh pin thereof will output a low level voltage will de-actuate the optical coupling IC (OP1) and the MOSFET Q1 will cut off so that the motor M1 and the direct current power source BP1 is disconnected. Thereby, the motor M1 is stopped. When the motor M1 stops, the elastomer will release potential energy so that the impact rod is accelerated to beat a nail. Since the sixth pin of the single chip controller IC2 outputs high level voltage will cause another optical coupling IC (OP2) to actuate and output voltage to another MOSFET Q2 to conduct the source and drain of the MOSFET Q2. As a result, the positive and negative electrodes of the motor M1 will short so that the motor M1 cannot operate. If it is desired to trigger the impact rod, the security switch SW1 must be turned off and then is turn on so as to reset the single chip controller IC2. Then the trigger switch SW2 is actuated again, the motor M1 will rotate again so as to achieve the protect effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A safety control circuit for a direct current electromotive nail driver comprising:
a direct current power source for supplying power to the circuit;
a control and protecting unit having a security switch, a trigger switch and a stop switch; and
a motor for driving an impact rod to compress an elastomer;
wherein when the security switch is turned on and then the trigger switch is pressed, the control and protecting unit will receive a signal from the trigger switch so as to conduct the motor and thus the motor operates to drive an impact rod to compress an elastomer; when the motor operates through a predetermined time period, the stop switch will actuates to induce a protection function of the control and protecting unit so that the motor can not operate until the security switch is actuated again.

2. The safety control circuit for a direct current electromotive nail driver as claimed in claim 1, wherein the motor is engaged to a gear to further drive an impact rod for beating a nail.

3. The safety control circuit for a direct current electromotive nail driver as claimed in claim 1, wherein when the impact rod of the motor moves to a predetermined position, the stop switch is actuated.

4. The safety control circuit for a direct current electromotive nail driver as claimed in claim 2, wherein the gear engaged to the motor rotates through a predetermined angle, the stop switch will be triggered.

5. The safety control circuit for a direct current electromotive nail driver as claimed in claim 1, wherein the control and protecting unit has a single chip controller for actuating and de-actuating the trigger switch and the stop switch.

6. The safety control circuit for a direct current electromotive nail driver as claimed in claim 1, wherein control and protecting unit has two optical coupling and two metal-oxide-semiconductor field effect transistors for actuating and de-actuating the motor.

7. A safety control circuit for a direct current electromotive nail driver comprising:
a regulating unit including a Zener diode and a regulating IC and a first capacitor and a second capacitor;
a control and protecting unit formed by a security switch, a trigger switch and a stop switch, a single chip controller, two optical coupling ICs; and two metal-oxide-semiconductor field effect transistors;
a direct current power source for supplying power to the circuit; and
a motor for driving an impact rod to compress an elastomer;
wherein when the security switch is turned on, current from the direct current power source flows through the Zener diode so as to confine the voltage to be within a predetermined voltage; then the current flowing through the regulating IC so as to output a steady voltage to the single chip controller IC; the regulating IC, and the two capacitors serve as a power source lower frequency filter.

8. The safety control circuit for a direct current electromotive nail driver as claimed in claim 7 wherein the motor is engaged to a gear to further drive an impact rod for beating a nail.

9. The safety control circuit for a direct current electromotive nail driver as claimed in claim 7 wherein when the impact rod of the motor moves to a predetermined position, the stop switch is actuated.

10. The safety control circuit for a direct current electromotive nail driver as claimed in claim 9, wherein the gear engaged to the motor rotates through a predetermined angle, the stop switch will be triggered.
